(19) United States
(12) Patent Application Publication
(10) Pub. No.: US 2019/0320590 A1
(43) Pub. Date: Oct. 24, 2019

(54) Adaptive Photosynthetically Active Radiation (PAR) Sensor With Daylight Integral (DLI) Control System Incorporating Lumen Maintenance

(71) Applicant: AGrow-Ray Technologies, Inc., Boulder, CO (US)

(72) Inventors: Hugh Patrick Adamson, Boulder, CO (US); Ivan Theodore Kruglak, Boulder, CO (US)

(21) Appl. No.: 16/384,573

(22) Filed: Apr. 15, 2019

Related U.S. Application Data
(60) Provisional application No. 62/660,002, filed on Apr. 19, 2018.
(60) Provisional application No. 62/660,039, filed on Apr. 19, 2018.

(51) Int. Cl. A01G 7/04; F21V 23/00; F21V 23/04; F21V 23/02; A01G 9/24; A01G 7/06; A01G 13/02

(52) U.S. Cl. CPC A01G 7/045; F21V 23/003; F21V 23/0464; F21V 23/02; F21Y 2115/10; A01G 7/06; A01G 13/0206; A01G 9/249; A01G 9/247

(57) ABSTRACT

An example adaptive Photosynthetically Active Radiation (PAR) sensor and controller system includes a hemispherical incident, translucent light housing that accepts light from above or from the sides in an artificial grow environment. A linear light sensor is positioned to receive light for the artificial grow environment, and an identical light sensor that is isolated from all light for the artificial grow environment. The identical light sensor functions as a temperature compensation device for the active photosensitive cell, A circuit supplies 0 to 10 VDC to a dimming input of a constant current LED driver to linearly dim an LED light according to at least measured intensity of light, from full-on to full-off as a direct inverse of the amount of sunlight received by linear light sensor, so that more sunlight causes more dimming of the LED light until at a predetermined threshold, the LED light is shut completely off.

### CROSS REFERENCE TO RELATED APPLICATIONS

This application claims the priority benefit of U.S. Provisional Patent Application No. 62/660,002 filed Apr. 19, 2018 for “Adaptive Photosynthetically Active Radiation (PAR) Sensor And Controller” (Attorney Docket No. 9880-001-PRV), and U.S. Provisional Patent Application No. 62/660,039 filed Apr. 19, 2018 for “Automatic System For Lumen Maintenance And Compensation” (Attorney Docket No. 9880-002-PRV), each hereby incorporated by reference in its entirety as though fully set forth herein.

### BACKGROUND

Traditional greenhouses are used to grow foods, flowers and other crops by providing a benign growing environment through control of light, temperature, humidity and other factors. This is done to optimize the growing environment, minimize the amount of water and nutrients used as well as to extend the growing season.

A key factor is the amount of available daylight. Seasonal variations limit the practicality of greenhouse use unless other factors are introduced such as heating and supplemental lighting. Both require external energy sources: Electricity for the lights, and a variety of possible sources for heat. When insufficient natural sunlight is available, supplemental, electric powered lights must be used. Light Emitting Diodes (LEDs), fulfil these needs and more. However, even LEDs degrade over time. Their color temperatures and wavelengths will change, and most importantly, the light output will diminish and the color spectrum will drift.

### BRIEF DESCRIPTION OF THE DRAWINGS

FIG. 1 is a block diagram of an example Adaptive Photosynthetically Active Radiation (PAR) Sensor and Controller.

FIG. 2 is a circuit diagram of an example printed circuit board which may implement an adaptive PAR sensor and controller.

FIG. 3 is a high-level illustration of output by an example printed circuit board.

FIG. 4 is a block diagram of a circuit which may implement an example automatic system for lumen maintenance and compensation.

FIG. 5 is a block diagram illustrating operations of an adaptive PAR sensor and controller.

### DETAILED DESCRIPTION

An Adaptive Photosynthetically Active Radiation (PAR) Sensor and Controller is disclosed as it may be implemented to govern the amount of supplemental lighting to make it as economical as possible to grow greenhouse crops.

The amount of supplemental lighting needed may depend at least to some extent on the latitude of the greenhouse, with far northern or far southern locations requiring progressively more supplemental lighting than near-equatorial locations.

The importance of having the correct light intensity and duration called Daylight Integral (DLI), cannot be overstated. For instance, crop production may be reduced by the lack of light and plants may either take a longer period to achieve the expected biomass production, or at harvest, the plants may be undersized or not fully developed. This can be a serious problem for flower producers who have hard deadlines such as Valentine's Day, Mother's Day, or Christmas. Likewise, growers with firm delivery contracts for produce and other crops may have contractual fines if the crops are not ready on time. However, if the amount of artificial light is above the required DLI, growers are wasting energy by providing light that cannot be used by the crop.

The cost of electricity is a key metric to the practicality and profitability of using supplemental lighting to hasten plant growth, and to provide the grower with additional, profitable crop cycles, healthier, more robust and larger plants which are worth more; provide the means to grow crops in the absence of sufficient sunlight. A corollary to the cost of electricity is that the method for producing light must be as efficient as possible, and produce a light spectrum and intensity that is optimal for growing plants of all sorts.

The cost of the electricity must be inexpensive enough and the luminaire efficient enough to provide the grower with a reasonable profit margin. This means that the amount of electricity must be tightly controlled to produce the best possible crop for the lowest possible electricity cost.

The most common source of supplemental light for greenhouse use is based on the old technology of arc lamps, used for street lighting from the 1870s and known today as High Pressure Sodium (HPS) lights. The spectrum is not ideal for plant growth, the light bulb output starts to drop fairly quickly and should be replaced after approximately 6 months of use. They also contain Mercury, a toxic, heavy metal. These lights are now being replaced by more efficient, LED (Light Emitting Diode) lights, with spectra and intensity tailored for efficient plant growth. Typical life is 50,000 hours (about 11 years, 12 hours per day) to 70% of the original output.

Unlike HPS lighting, LED lights have additional advantages such as being easily dimmable over a wide range. A typical LED driver may be dimmed from 100% output to less than 10%.

The devices, systems, and their methods herein may be employed not only for the improvement of plant crop growth, but as well for the propagation and cultivation of horticultural products. The sensor system described herein provides a supplemental interactive lighting system for enhancing plant and/or crop growth. The supplemental lighting system may also include one or more gateways, servers, wireless or wired nodes, microprocessors, and networks. Such a network may be connected to cloud- based storage. The system may additionally include memory devices, a controller, such as a lighting control system, a smart condition monitor to check environmental conditions, electricity (voltage, current, power, various thresholds), plant physiology sensors, a wired/wireless communications system, and/or a light element control module such as physically and/or electrically coupled to a light fixture.

Before continuing, it is noted that as used herein, the terms “includes” and “including” mean, but is not limited to, “includes” or “including” and “includes at least” or “including at least” The term “based on” means “based on” and “based at least in part on.” In addition, the following terms are also defined as used herein.

The term photosynthetically active radiation (PAR) is used herein to designate the spectral range (wave band) of solar radiation from 400 to 700 nanometers that photosynthetic organisms are able to use in the process of photosynthesis.

The term daily light integral (DLI) is used herein to refer to a function of photosynthetic light intensity and duration (day) and is usually expressed as moles of light (mol) per square meter (m−2) per day (d−1), mol. In other words, DLI describes the sum of the per second PPFD measurements during a 24-hour period. As indicated above, the daily light integral (DLI) is the amount of photosynthetic active radiation (PAR) received each day as a function of light intensity (instantaneous light: μmol·m−2·s−1) and duration (day). It is expressed as moles of light (mol) per square meter (m−2) per day (d−1), or: mol·m−2·d−1 (moles per day). The DLI concept is like a rain gauge. Just as a rain gauge collects the total rain in a particular location over a period of time, so DLI measures the total amount of light (PAR) received in a day. Greenhouse growers can use specialized light meters to measure the number of light photons that accumulate in a square meter over a 24-hour period to obtain readings in moles.

DLI is an important variable to measure in every greenhouse because it influences plant growth, development, yield, and quality. For example, DLI can influence the root and shoot growth of seedlings and cuttings, finish plant quality (characteristics such as branching, flower number and stem thickness), and timing. Commercial growers who routinely monitor and record the DLI received by their crops can easily determine when they need supplemental lighting or retractable shade curtains.

It is noted that luminaires using Light Emitting Diodes (LEDs) of different wavelengths, including but not limited to white light, provide an efficient and optimized plant growth spectrum and intensity. Although LEDs are referred to herein as the most current technology for supplying light to plants, nothing herein limits the technology described to LEDs. Other means to produce light may be in existence, or may be developed in the future that may also be implemented. The technology described applies equally to other means of generating light.

It is noted that the examples shown and described are provided for purposes of illustration and are not intended to be limiting. Other devices and/or device configurations may be utilized to carry out the operations described herein. The operations shown and described herein are provided to illustrate example implementations. It is noted that the operations are not limited to the ordering shown. Still other operations may also be implemented.

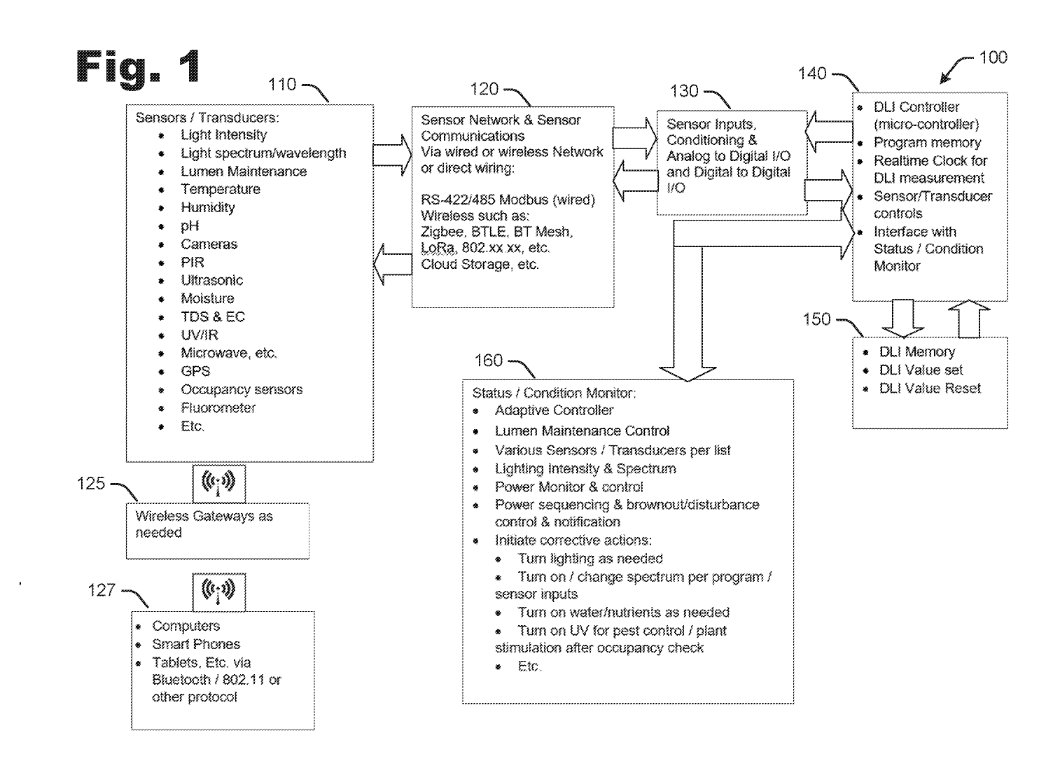

FIG. 1 is a block diagram of an example Adaptive Photosynthetically Active Radiation (PAR) Sensor and Controller. The example system 100 in FIG. 1 includes any number and/or types of sensors and/or transducers 110 to implement the operations described herein. In an example, the sensors and/or transducers 110 may be interconnected via a sensor communications network 120 and conversion 130 to provide input to a light controller 140. Suitable wired and/or wireless gateways 125 for implementing via computer device(s) 127 such as but not limited to, smart phones, tablets, etc. The light controller 140 may include computer-readable storage 150, and may implement various controls/controllers 160.

In an example, the system includes a light sensor and circuitry to linearly respond to ambient light. In the fashion of a camera light meter, it measures the light falling on its sensor from all reasonable angles. This is called an incident light sensor.

The sensor is calibrated so that when sunlight reaches a certain light (PAR) level, the LED light linearly dims to off. This PAR level is factory or field calibrated to respond to the optimum light level for the crop in question. As an example, the PAR setting might be 200 uMols for lettuce, a low light level plant, and 500 uMols for tomatoes, which require more light. The location of this sensor is important. In an example, all sensors used must be placed above the light fixture(s) so as to receive direct sunlight and not be influenced by the fixture being on, off or partially dimmed. Because the Sun is approximately 93 million miles distant, the actual location above the light fixtures is unimportant as long as the sensor is not occluded by the greenhouse or other structures or objects.

An example system includes a hemispherical incident, translucent light housing that accepts light from above or from the sides. The example system also includes a linear light sensor (e.g., a solar cell, or any other light sensitive device such as a photodiode or phototransistor to which a linearizing circuit has been added), and an identical sensor that is “blind” (isolated from all light) that functions as temperature compensation device for the active photosensitive cell. The output of this circuit supplies 0 to 10 VDC to the dimming input of a constant current LED driver to linearly dim the LED light. The intensity of the light, from full on to full off is the direct inverse of the amount of sunlight received by the calibrated photosensor. That is, more sunlight may cause more dimming of the LED lights until at a predetermined threshold, the light shuts completely off.

During operation, if a cloud passes overhead, the ambient light might drop by, for example, 30%. If there had been sufficient sunlight to keep the controlled lights off, they might turn on if the light levels at the sensor dropped below the calibrated PAR level. However, the sensor might measure sufficient residual light to respond by turning on the LED light it controls, to only 20% of its maximum output, so that the sum of the sunlight plus the artificial light adds to 100% of the light required by the plant to achieve the quickest and healthiest growth. A cloudy or rainy day might produce lower PAR levels at the sensor and the system would respond by turning on the lights anywhere up to a full, 100%.

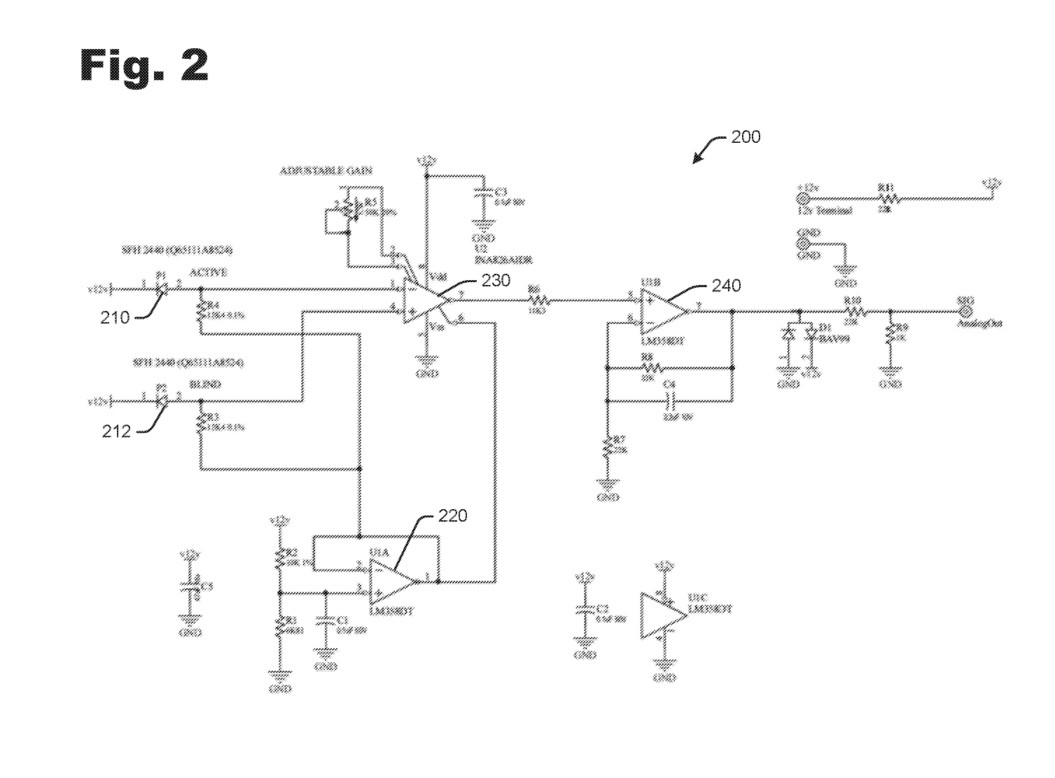

FIG. 2 is a circuit diagram 200 of an example Adaptive Photosynthetically Active Radiation (PAR) Sensor and Controller. In an example, the circuit 200 includes two photo sensors P1 210 and P2 212 biased with U1A 220 output voltage (4.85V). Both P1 210 and P2 212 are inputs for the differential amplifier U2 230.

The blind sensor (P2) 212 is covered with INDIA INK, or other means of 100% light blocking, such as opaque adhesive tape, and acts as a temperature compensation because it is biased at the same place as the active sensor P1 210 and has the same bias current. As the temperature changes, and if P1 210 saw no light, it forces the differential amplifier to the voltage created by U1A 220 (about 4.85V). But, because P1 210 is not blind, the output of U2 230 is the temperature compensated value of P1 210. U2 230 can have gain from 1 to about 50,000 allowing it to respond to very low light levels or very high light levels, depending on the gain setting.

U1B 240 is an amplifier with a gain of 2. For no light received by P1 210, U2 230 is biased at about 4.85 volts and there is 9.70V out of U1B 240. As P1 210 receives light, the differential amplifier U2 230 goes from about 4.85 to approaching ground (0 Volts). With a gain of 2, the output voltage to the LED driver goes from about 9.70 V for no light, to about 0 for full light. Full light is created by calibrating the gain of U2 230 such that at the chosen intensity seen by P1 210, it causes the differential amplifier U2 230 to go to about 0 volts.

As the dimming control of the LED driver function is 9 to 10 V for full intensity and 0 to 1V for LEDs off, this causes the LED driver to be at full power when there is no light at P1 210. No light at P1=4.85 volts out of U2=9.7V out of U1B 240, and at full light (U2 at 0 volts=U1B to be 0V) causes the LED driver to turn the LEDs off when the light intensity reaches full light.

In an example, the sensor is inexpensive enough so that each light in a greenhouse or similar venue, may be equipped with its own sensor. This provides the maximum flexibility to the grower as one part of the greenhouse might be shadow, where supplemental light is needed, while a different area may have sufficient sun to dim or shut off the lights in this section.

The above described sensor system is extremely effective. However, in some circumstances, another level of sophistication is desirable. In an example, the system may further include means to measure and record the DaylightIntegral.

Briefly, most common plants need a certain minimum amount of light over a 24-hour period. This value has largely been determined via established research. For instance, lettuce production has been shown to require 12 to 14 mol_m−2_d−1, and tomatoes need 20 to 30 mol_m−2_d−1. It is therefore very important that the total amount of light received by a plant be known. With this information, if insufficient light were received during a rainy or winter's day, for instance, the supplemental light can be turned on for the length of time required to make up the difference between the light received and the light required.

The system with DLI control can be implemented in a variety of ways. For example, the system may include a microcontroller measurement system featuring an analog to digital input to measure the output of the photosensor to keep track of the light levels over a given time. The microprocessor may also include a precision real time clock system to keep accurate time of day. This clock may be synchronized to the sensor output levels to measure the amount of time that sufficient light and duration were received.

Greenhouses, or similar venues may wish to grow different crops at different times. As noted above, different crops require different amounts of light. The system may be reset to provide the correct DLI for the crop to be grown. The LED Light dimming to completely off threshold may be changed either locally or remotely to the correct PAR threshold setting.

The system with DLI control as described, can either be freestanding (one per light), or part of a network. A network can be constructed using a variety of technologies, not limited to the following: a wireless network using one or more protocols such as WiFi (802.11.xx, Zigbee (802.15.4) Bluetooth (802.15.1), or wired protocols such as Modbus over RS-485, RS-422, or a combination. A network approach may be especially valuable in large installations to keep track of hundreds or even thousands of controller-equipped lights.

Many electric power companies charge different amounts per kilowatt-hour (kWh) depending on time of day. To economize on the electricity cost, growers may wish to have their lights come on during the period of cheapest rates, typically late at night to early morning, to avoid peak power rates. An additional level of sophistication can be incorporated in the system with DLI control and real-time clock, or off-loaded to a desktop, laptop or other computer. Equally, a smartphone application or other means may be utilized for scheduling the on/off times for these lights. Additionally, staggered turn on/off times may be programmed to avoid massive turn on power surges and turn off transients. These features may also be triggered by power failure, brown-outs, over-voltage conditions, and the like.

Another implementation of the system, may accept inputs from wireless or wired sensors such as, but not limited to temperature, humidity, CO2, and pH. The various sensor readings may be input to the system for further transmission via wired or wireless means to a computer, smartphone or other data gathering, control and display device or devices via a network or other means.

Advanced sensing devices may be used, such as a fluorometer, configured for measuring a chlorophyll fluorescence emission of a plant. These emissions may be employed so as to determine one or more characteristics of a photosynthesis process. For instance, in various embodiments, the electron transport rate may be determined by the measuring of chlorophyll fluorescence emission for the purpose of optimizing the growth process, including, but not limited to speed of growth, health of plant, and nutritive value.

Another implementation of the system, may accept a wireless or wired input to cause the LED light to alter the light spectrum created by the LEDs. Alternately, the system may implement its onboard Real Time Clock to initiate spectrum changes as described below. To actually change colors, the system may drive a multi-channel LED driver, or multiple individual drivers (one channel per light color. White is considered as a color for this purpose).

By way of illustration, Spectrum A is implemented with seedlings, clones or other delicate plants. It has been shown that many young plants benefit from a Blue-weighted spectrum, so let us call Spectrum A, Blue weighted. As the plants mature and begin to flower, a different spectrum is more effective to promote growth, flowering and beneficial characteristics such as, but not limited to, color, taste, smell and potency. Spectrum B, in many instances is red weighted, so the system may switch to Spectrum B, and to Spectrum C, D and so on, as needed. Since this implementation includes a precision real time clock, it can be programmed to switch spectra, or other functions, after a certain period of time. Alternately, the system may accept a wireless or wired input to effect these spectrum changes remotely, either from appropriate sensors or via timing or human/machine control

Another implementation of the system can include means to measure plant height, leaf distance or other physical measurements via ultrasonic transducers, photosensors or other means. This function can alert the grower when a particular plant is ready for harvest or signal a motor that the light may be raised to prevent plant contact with the light, and/or to maintain an optimum height above the plant for ideal light dispersion and intensity.

Another implementation of the system can include means via wavelength selectable sensors, moisture sensors, or other means, to detect insect or other pests, fungal presence, lack of sufficient water, nutrients or other unhealthy conditions. This information may then be relayed via the system which is networked via wired or wireless means to a computer, smartphone or other data gathering, control and display device or devices.

Another implementation of the system can include means upon detection of pests, fungal presence, lack of sufficient water, nutrients or other unhealthy conditions to actively counteract these unhealthy conditions by, for instance, remotely turning on local watering, nutrient supply, UV light to eradicate pests, or other means to accomplish plant health restoration. This information may then be relayed via the system which is networked via wired or wireless means to a computer, smartphone or other data gathering, control and display device or devices.

Another implementation of the system can include means such as Passive Infrared (RR), or microwave sensors to detect motion in the local environment, due to intruders, rodents or other motion-triggered events. This information may then be relayed via the system which is networked via wired or wireless means to a computer, smartphone or other data gathering, control and display device or devices. Since each light can be equipped with these sensors, including video cameras, making precise location and movement tracking in a large facility possible. This information can be sent directly to a security company, police department, and/or a person responsible for the facility.

Another implementation of the system can include means to detect fire and smoke via appropriate sensors and transmit this information via wired or wireless means to a computer, smartphone or other data gathering, control and display device or devices via a network or other means, and/or directly to a security company, fire department, and/or a person responsible for the facility.

Another implementation of the system can be to control and electronically activate a shade mechanism, common to greenhouses, to provide shade to a plant or plants, so as to alleviate heat or light stress in plants caused by over exposure to lighting, such as during the summer months when there is an overabundance of daylight. Equally, the system can retract this shading device when the heat and peak light of the day (for instance), has passed, based on its PAR, temperature or other measurements.

Another implementation of the system can include means to detect human presence or absence, called occupancy detection. Existing PIR sensor(s) may be also be used for this. If no humans are present, UV light may be switched on safely, to eradicate pests and/or to promote flowering and other beneficial attributes.

When data is available from the electric utility company, or any other data is available from other sources, such as weather, costs associated with growing crops, such as water or nutrient costs, market prices for relevant crops, the computer, smart phone or alternate data storage and display devices associated with the system can retrieve, store and act on the received data to minimize the economic impact of this data, or notify the person supervising the greenhouse to take advantage of a particular situation.

It is noted that the examples shown and described are provided for purposes of illustration and are not intended to be limiting. Still other examples are also contemplated.

Greenhouses and other facilities may have very large spaces, typically measured in acres. There may be thousands of lights in use at larger facilities. These are commonly LED-based lights (luminaires), having TM-21 projected lifetimes of 25,000, 50,000 or even 100,000 hours, equating to 5.5, 11 and 22 years respectively, at 12 hours on per day. These luminaires may have been installed at different times, represent different brands and models, and therefore pose a very difficult maintenance task to track projected lifetimes and reduced light (L70) levels over time.

A further complication is the L70 data may not be available or reliable. It also will not represent each luminaire, only an average. The human eye is not particularly sensitive to intensity changes. Detecting early failures or unexpected reduced light output may not be timely. A 30% loss of light (L70 limit) may not seem like very much, but it would have serious financial consequences to a grower who is not getting the expected results, and not understand why. It may even create liability issues, poor working conditions and/or may have other undesirable consequences with general lighting applications.

An example automatic system for lumen maintenance and compensation is disclosed which compensates for the loss of light output of a luminaire (or other light) over the light source lifetime (e.g., LED or other lighting source), as well as an end of life indication, or intermediate status. The systems and methods described herein may be implemented for lighting at greenhouses or other agricultural venues where artificial lighting is used for growing crops, and may also have general applicability in other lighting scenarios for general illumination.

In addition, IES LM-80-2008, “Measuring Lumen Maintenance of LED Light Sources” (“LM-80”), is the industry standard that defines the method for testing LED lamps, arrays and modules to determine their lumen depreciation characteristics and report the results. The goal of LM-80 is to allow a reliable comparison of test results from different laboratories by establishing uniform test methods. IES TM-21-2011, “Projecting Long Term Lumen Maintenance of LED Light Sources” (“TM-21”) is the technical memorandum that recommends a method of using LM-80 test results to determine the rated lumen maintenance life (Lp) of LED lamps. L70 is an IESNA approved method of testing Projecting Long Term Lumen Maintenance of LED Light Sources, which establishes a method for projecting lumen maintenance (and useful lifetime) of LED light sources from available LM-80 data and INSITU data. This is based on “time to failure” or when the luminous flux reduces to 70% of its original output. Example: L70 Calculated Estimates—134,273 hrs. @ 25° C. Ambient and 425 mA.

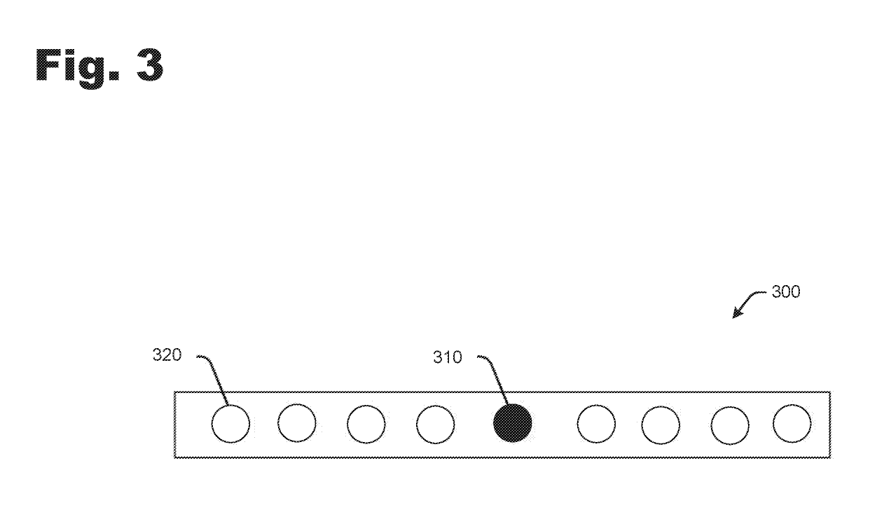

FIG. 3 is a high-level illustration of output by an example printed circuit board (PCB) 300, wherein white dots 320 represent LED or other light sources, and the black dot 310 represents a sensor. LED Luminaires are typically powered by a constant current DC source. Most have a dimming means, usually, a 0 to 10 VDC or PWM signal that produces a corresponding, linear dimming. In an example, the circuit may be implemented to regulate the light output.

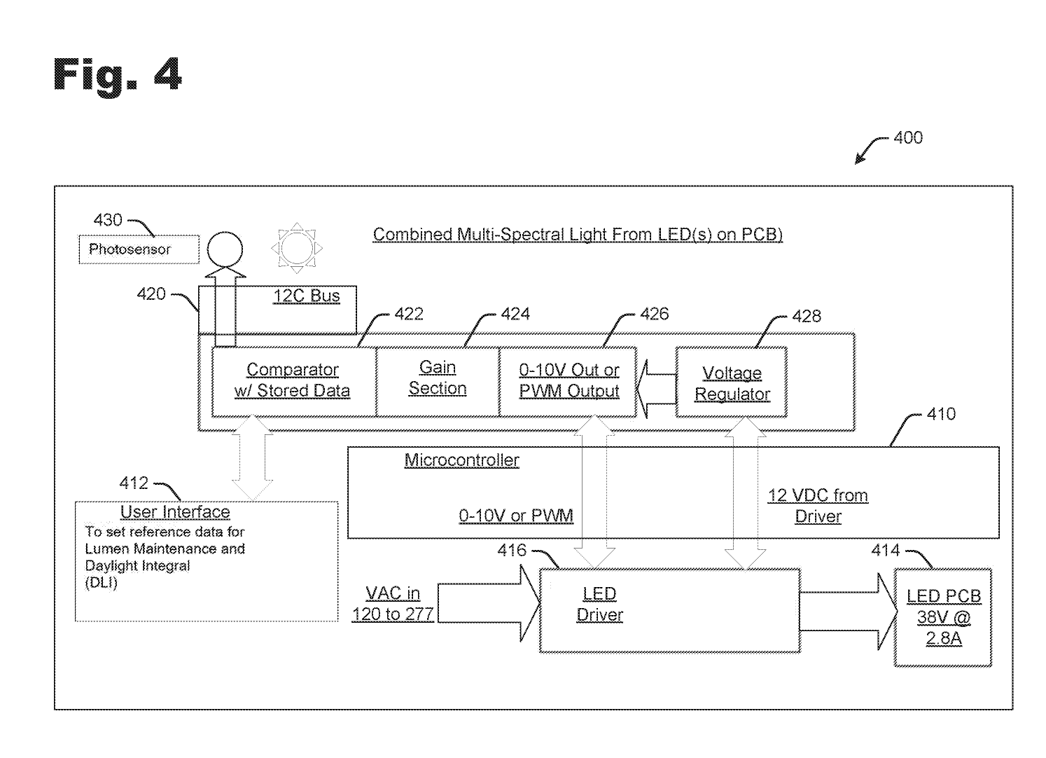

FIG. 4 is a block diagram 400 of a circuit which may implement an example automatic system for lumen maintenance and compensation. This system may be implemented as an open or closed-loop circuit, with a closed-loop circuit preferable for accuracy. In an example, the circuit may include an 8-bit microcontroller 410 based sensor solution. The microcontroller 410 may interface with a user interface 412 and LED circuit 414 via LED driver 416. An I2C bus 420 may connect to an I2C sensor 430, one that can tolerate 60,000 Lux or more. The I2C bus 420 may interface with a comparator 422, a gain section 424, PWM output 426, and a voltage regulator 428. Two spectral channels may provide a good indication of the spectral content. An example sensor is a commercially available TSL2772_DS000181_2-00-255425.

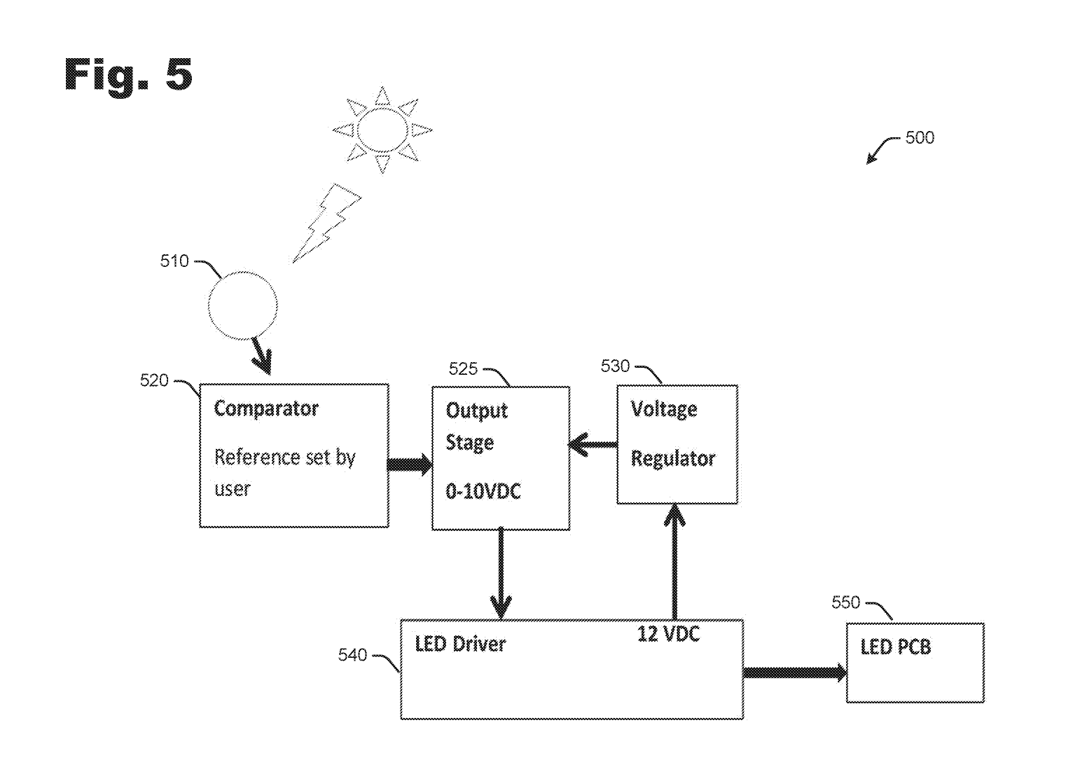

FIG. 5 is a block diagram illustrating operations 500 of an adaptive PAR sensor and controller. The actual light output is measured when the light source (e.g., LED) is new, and that measurement is used as a reference set point by the luminaire electronics and a solar cell. A solar cell 510 or linearized photodiode, phototransistor or other light sensitive device such as an LDR (light dependent resistor), along with suitable electronics are calibrated at this setpoint. The setpoint data is stored in a memory device that is part of the luminaire electronics.

In use, the light sensitive cell is mounted on the luminaire such that it is in the direct or reflected path of the light and is constantly illuminated by the light, directly, or indirectly via a reflector or light pipe. The solar cell signal is monitored by a comparator 520 to adjust the dimming voltage 525 up or down as needed via voltage regulator 530, output to the LED driver 540 and the LED circuit 550. The error signal is conditioned and then used to directly drive an LED controller's dimming input.

By way of illustration, if the luminaire is rated for continuous use at 130 Watts, the driver also is rated for 130 W. When the luminaire is new, the driver operates at a 30% dimming value of 100 W. Over time, the control system may up the current to compensate for lumen depreciation, to a maximum of 130 W in this example. At this point (or at any desired percentage) a warning signal may be issued. For example, a red light on the luminaire may be lit, or the luminaire may be operated to flash on and off. Other means may also be implemented, such as but not limited to a wireless or wired data signal transmitted to a central reporting station to alert the maintenance personnel to change the light.

A second technique to determine the LED status is to monitor the current use by the luminaire. A drop in current correlates to a drop in the LED light output. A series shunt in the LED Light DC line may be monitored for voltage fluctuations, including a voltage (IR) drop. This voltage may be fed to an analog to digital input of a microprocessor, which performs the necessary housekeeping. For example, the microprocessor may increase the LED current to compensate for LED depreciation. Or for example, the microprocessor may notify the user of end-of-life or an intermediate drop in light output level, via a wired or wireless signal.

Another technique is to combine the first and second techniques described above, to give a more sophisticated and robust light compensation and notification means.

It is noted that the examples shown and described are provided for purposes of illustration and are not intended to be limiting. Still other examples are also contemplated.

1. A method for measuring the amount of light received over 24 hours, comprising:
measuring natural lighting received by plants in an artificial grow environment; and;
controlling an artificial light source to provide a predetermined optimum amount of light for plants in the artificial grow environment.

2. The method of claim 1, further compromising controlling intensity, duration and spectral content of the artificial light source.

3. The method of claim 1, further compromising controlling electrical power of the artificial light source.

4. The method of claim 1, further compromising controlling an input to the light source to cause an LED light to alter a light spectrum output by the LED light, wherein different weighted spectrums and intensities are implemented based on stage of growth of the plants in the artificial grow environment.

5. The method of claim 4, further compromising controlling:
a Real Time Clock (RTC) for the light source to initiate spectrum changes; and
a multi-channel LED driver or multiple individual LED drivers to change color output of the LED light.

6. The method of claim 1, further compromising measuring plant height, via ultrasonic transducers, photosensors or other sensors to signal a motor that the light source should be raised to prevent plant contact with the light to maintain an optimum height of the light source above the plant for ideal light dispersion and intensity until harvest of the plant.

7. The method of claim 1, further compromising detecting, via wavelength selectable sensors, moisture sensors, or other sensors, to detect insect or other pests, fungal presence, lack of sufficient water, nutrients or other unhealthy growing conditions for the plant.

8. The method of claim 1, further compromising:
upon detection of pests, fungal presence, lack of sufficient water, nutrients or other unhealthy conditions, to actively counteract the unhealthy conditions by remotely turning on local watering, nutrient supply, UV light to eradicate pests, and other plant input devices to accomplish plant health restoration; and
detecting presence/absence of humans to safely turn on UV lighting.

9. The method of claim 1, further comprising electronically activating a shade to provide shade to the plant to alleviate heat or light stress caused by over-exposure to lighting, based on PAR measurements.

10. An adaptive Photosynthetically Active Radiation (PAR) sensor and controller system, comprising:
a hemispherical incident, translucent light housing that accepts light from above or from the sides in an artificial grow environment;
a linear light sensor positioned to receive light for the artificial grow environment, and an identical light sensor that is isolated from all light for the artificial grow environment, the identical light sensor functioning as a temperature compensation device for the active photosensitive cell; and
a circuit to supply 0 to 10 VDC to a dimming input of a constant current LED driver to linearly dim an LED light according to at least measured intensity of light, from full-on to full-off as a direct inverse of the amount of sunlight received by linear light sensor, so that more sunlight causes more dimming of the LED light until at a predetermined threshold, the LED light is shut completely off.

11. The system of claim 10, wherein the linear light sensor measures actual light output when the LED light is new as a reference set point for output by the constant current LED driver.

12. The system of claim 11, wherein the linear light sensor is calibrated at the reference set point.

13. The system of claim 10, wherein the linear light sensor is mounted on a luminaire such in a direct or reflected path of the light and is constantly illuminated by the light, directly, or indirectly via a reflector or light pipe.

14. The system of claim 10, wherein the linear light sensor is monitored by a comparator to adjust dimming voltage up or down as needed.

15. The system of claim 10, wherein an error signal is conditioned and then used to directly drive dimming input of the constant current LED driver.

16. The system of claim 10, wherein over time, the constant current LED driver increases current output to compensate for lumen depreciation.

17. The system of claim 16, wherein at the maximum value for lumen depreciation, the circuit issues a warning signal to replace the LED light.

18. The system of claim 17, wherein the warning signal is at least one of:
a warning light on a luminaire is lit;
a luminaire is operated to flash on and off;
a wireless or wired data signal transmitted to a central reporting station to alert maintenance personnel.

19. The system of claim 10, wherein the circuit monitors current use by a luminaire, and a drop in current correlates to a drop in light output by the LED light.

20. The system of claim 10, further comprising a series shunt in a DC line of the LED Light that the circuit monitors for a voltage fluctuation, including a voltage (IR) drop, and the voltage fluctuation is fed to an analog to digital input of a microprocessor of the circuit to increase current to the LED light to compensate for LED depreciation.

21. The system of claim 10, wherein the linear light sensor positioned above the housing to receive direct sunlight and without being influenced by artificial light being on, off or partially dimmed.
